(19) United States
(12) Patent Application Publication
(10) Pub. No.: US 2025/0314185 A1
(43) Pub. Date: Oct. 9, 2025

(54) IGNITED REDUCING COMPOSITIONS AND METHODS FOR CATALYTICALLY DECOMPOSING EXHAUST GAS MIXTURES

(71) Applicant: Altered Labs LLC, Miramar, FL (US)

(72) Inventor: Dario ECHEVERRY CAMPOS, Miramar, FL (US)

(21) Appl. No.: 18/863,280

(22) PCT Filed: May 5, 2023
(86) PCT No.: PCT/US2023/066656

§ 371 Date: Nov. 5, 2024

Related U.S. Application Data
(60) Provisional application No. 63/338,616, filed on May 5, 2022.

(51) Int. Cl. F01N 3/035; F01N 3/025; F01N 3/029

(52) U.S. Cl. CPC F01N 3/035; F01N 3/0256; F01N 3/0293; F01N 2250/10; F01N 2610/1453; F01N 2610/1493

(57) ABSTRACT

A method of decomposing particulate pollutants present in exhaust gases is disclosed. Also disclosed are compositions for use in the method for cleaning exhaust gases, as well as methods of preparing said compositions. Also disclosed are systems configured to carry out a decomposition process to remove particulate pollutants from exhaust gas.

### CROSS-REFERENCE TO RELATED APPLICATIONS

This application claims the benefit of the filing date of U.S. Provisional Application Ser. No. 63/338,616, filed May 5, 2022, the entire contents of which are incorporated by reference herein

### BACKGROUND OF THE INVENTION

Combustion efficiency has been and continues to be a challenge to the world of engineering for more than a century, going back to the industrial revolution.

Taking sulfur pollution as merely a single example, less than 5% of the world's largest ships now emit as much pollution as all the world's automobiles (i.e., about 800 million cars and SUVs).

At present, existing methods for alleviating the problem of air pollution focus on (i) improving the quality of the combustibles (i.e., diesel. bunker fuel oil, coal, gasoline, etc.) by reducing the number of impurities present therein (i.e., sulfurs, ammonia, non-combusted carbon, noncombustible particles, etc.); (ii) using catalytic converters and scrubbers at the end of combustion processes; and (iii) recommending the non-use of carbon-based fuels (e.g., encouraging or incentivizing the use of electric vehicles, wind energy, and other “green” energy sources).

Chief among sources of air pollutants are stacks. Stacks are essentially small, medium, and large industrial chimneys designed to emit and disperse hot air, particulate matter, and pollutants into the atmosphere at such a height that they do not constitute a danger to surrounding life (e.g., on the ground). Use of stacks is not a solution to the problem of air pollution produced by industrial processes, however. Rather, stacks merely represent a palliative measure meant to make living conditions more comfortable without eliminating or otherwise addressing the real problem of air pollution and the effects of global warming attributable to air pollution such as greenhouse gases.

Historically, the basic function of smokestacks has been to provide natural draft for combustion reactions, thereby providing a dispersion of pollutant species. In general, and under typical conditions, the primary focus of stack design has been concerned with the draft to be produced, the frictional pressure loss, the structural design of the stack itself, and foundation and selection of suitable construction materials.

With the introduction of mechanical draft systems, the function of stacks has markedly changed to one of controlling air pollution through effective effluent dispersal. Stack designers now frequently find themselves selecting stack heights and locations based on meteorological conditions and desired ground level contaminant concentrations.

Other types of stacks include stacks provided or located on or in boats, ships and modes of land transportation, such as trains, trucks (e.g., semis) and heavy machinery (e.g., construction equipment).

There is thus an ongoing need for new compositions and methods useful for eliminating or reducing the overall level of air pollutants produced by combustion reactions, such as combustion reactions taking place in stacks or combustion reactions which produce air pollutants disperse via stacks. The present invention provides for a “plug-and-play” method of thermal-catalytic exhaust decomposition, which is a unique and efficient solution for any of these problems.

Electrolysis of water has been explored as a potential means for producing a reducing gas. Examples of reducing gases include oxyhydrogen (a.k.a Knell gas), Brown's Gas, Tylar Gas, Hydrogas™ and HHO Gas (a.k.a. Klein Gas). Most of these gases, when ignited, induce a thermal-catalytic heat into materials with which the gases come into contact, thereby inducing them to transition between phases (e.g., to melt or vaporize).

Certain embodiments of the present inventive method involve injecting (i) an ignited reducing gas and/or an ignited composition comprising at least one reducing gas and (ii) a combustible gas into a polluting exhaust using one or more nozzles. The polluting exhaust may be from, for example, an engine aboard a tanker or from a power generator, combustion engine, stack, or any other source that produces pollutant gases.

By way of the present invention, the pollutant species (i.e., particulate pollutants) present in the polluting exhaust will be thermally and catalytically decomposed into non-polluting, inert components.

The present invention is directed to compositions, and methods of use thereof, for decomposing pollutants introduced by polluting gases.

In certain embodiments, the present invention is directed to compositions for use in preparing a reducing gas, such as an ignited reducing gas. In other embodiments the present invention is directed to methods for preparing a reducing gas, such as an ignited reducing gas. In still other embodiments, the present invention is directed to methods for preparing compositions comprising one or more reducing gases, such as ignited reducing gases.

The present invention is also directed to compositions and methods for decomposing a polluting gas. The present invention is also directed to compositions and methods for lowering the amount of pollutant species produced by an industrial process. In certain embodiments, the present invention is directed to a reaction vessel or stack in which a composition or method described herein is provided or carried out to decompose pollutant species.

### SUMMARY

The present disclosure provides for a method for decomposing particulate pollutants in an exhaust source, the method comprising (i) injecting, via a first series of nozzles, a reducing gas into the exhaust source comprising the particulate pollutants, (ii) injecting, via the first series of nozzles or a second series of nozzles, a combustible gas into the exhaust source, and (iii) igniting the combustible gas in the presence of the reducing gas, thereby decomposing the particulate pollutants.

The present disclosure also provides for a method for decomposing particulate pollutants in an exhaust source, the method comprising (i) infusing a liquid with a reducing gas and a metasilicate, wherein the infusing involves mixing under turbulent conditions, wherein the reducing gas and/or the metasilicate reacts with the aqueous solution to produce a reducing liquid having the oxidation reduction potential (ORP) value of about −100 mV or more negative, (ii) injecting or spraying, via a first series of nozzles, the reducing liquid into the exhaust source comprising the particulate pollutants, (iii) injecting, via the first series of nozzles or a second series of nozzles, a combustible gas into the exhaust source, and (iv) igniting the combustible gas in the presence of the reducing liquid, thereby decomposing the particulate pollutants.

The present disclosure also provides for a system for decomposing particulate pollutants, the system comprising: (a) a chamber (e.g., in an exhaust stack) receiving particulate pollutants from an exhaust source; (b) a heating source or ignition source; and (c) a plurality of nozzles, each nozzle injecting into the chamber either: (i) reducing fluid from a reducing fluid exit line and combustible gas from a combustible gas exit line, wherein the reducing fluid exit line receives reducing fluid from a reducing fluid injection line and the combustible gas exit line receives combustible gas from a combustion gas injection line, or (ii) a mixture of reducing fluid and combustible gas from a single fluid exit line, wherein the reducing fluid flows into the single fluid exit line via a reducing fluid injection line and the combustible gas flows into the single fluid exit line via a combustible gas injection line, or (iii) a combination of (i) and (ii), wherein the nozzles and fluid injection lines are configured so that both the reducing fluid and the combustible gas are injected or sprayed into the chamber, and wherein the heating source or ignition source ignites the combustible gas injected or sprayed into the chamber in the presence of the reducing fluid, thereby resulting in decomposition of the particulate pollutants in the chamber and reduction in particulate pollutants exiting the chamber or exhaust.

Other aspects of the present invention will be made apparent by the following detailed description. Additional aspects of the present invention will be readily apparent to a person of ordinary skill in the art in view of the following disclosure.

### BRIEF DESCRIPTION OF THE DRAWINGS

Various features of illustrative embodiments of the disclosure are described below with reference to the drawings. The illustrated embodiments are intended to illustrate, but not to limit, the disclosure. The drawings contain the following figures:

FIG. 1 shows a diagrammatic representation of a non-limiting embodiment of the method of the present invention.

FIG. 2 shows a first non-limiting configuration of nozzles configured to introduce a reducing fluid and combustible gas into an exhaust stack, wherein the nozzles are arranged in rings positioned within the exhaust stack.

FIG. 3 shows another non-limiting configuration of nozzles configured to introduce a reducing fluid and/or combustible gas into an exhaust stack, wherein the nozzles are arranged in a spiral or helical arrangement.

### DETAILED DESCRIPTION

Set forth below with reference to the accompanying drawings is a detailed description of compositions and methods useful for eliminating or reducing the overall level of air pollutants produced by combustion reactions, such as combustion reactions taking place in stacks or combustion reactions which produce air pollutants disperse via stacks. The appended drawings are incorporated herein and constitute a part of the detailed description.

The detailed description set forth below is intended as a description of various configurations of the subject technology and is not intended to represent the only configurations in which the subject technology may be practiced. The detailed description includes specific details for the purpose of providing a thorough understanding of the subject technology. However, it will be apparent to those skilled in the art that the subject technology may be practiced without these specific details.

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

### Definitions

Unless otherwise defined, all technical and scientific terms used herein have the same meaning as commonly understood by a person having ordinary skill in the art to which the present invention belongs. While methods and materials similar or equivalent to those described herein can be used to practice the invention, suitable methods and materials are described herein. All publications, patent applications, patents, and/or other references mentioned herein are incorporated by reference in their entireties. In the event that any of the publications, patent applications, patents and/or other references mentioned and incorporated herein contradict the present disclosure, the present disclosure including the definitions is authoritative. Additionally, the materials, methods, and examples are illustrative only and are not intended to be limiting.

Amounts, concentrations, ratios disclosed herein are exemplary only, and a person of ordinary skill in the art may use other amounts, concentrations or ratios in light of the following disclosure.

The processes and protocols and other methods described herein are disclosed for exemplary, illustrative purposes only. The processes, protocols and methods may vary in other exemplary uses of the methods.

The articles “a” and “an” are used herein to refer to one or to more than one (i.e., to at least one) of the grammatical object of the article. By way of example, an element means one element or more than one element.

As used herein in reference to a value, the term “about” refers to a value that is similar, in context to the referenced value. In general, those skilled in the art, familiar with the context, will appreciate the relevant degree of variance encompassed by “about” in that context. For example, in some embodiments, the term “about” can encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or less of the referred value. The details of one or more embodiments of the invention are set forth in the accompanying drawings and the description below. Further features, objects and advantages of the invention will become apparent from the description and the drawings as well as from the claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

All numerical ranges defined herein are inclusive of endpoints and all values thereinbetween, unless otherwise specifically stated. For example, “at a concentration of a-b” means “at a concentration of at least a and at most b.”

As used herein, the term “agent” refers to a substance, entity or complex, combination, mixture or system, or phenomenon (e.g., heat, electric current or field, magnetic force or field, etc.).

As used herein, “associated with” denotes a relationship between two events, entities and/or phenomena. Two events, entities and/or phenomena are “associated” with one another, as that term is used herein, if the presence, level and/or form of one is correlated with that of the other.

As used herein, “combustible gas” means a gas that can burn in the air or in the presence of oxygen and includes oxygen itself.

Those skilled in the art will appreciate that the term “composition”, as used herein, can be used to refer to a discrete physical entity that comprises one or more specified components. In general, unless otherwise specified, a composition can be of any form, e.g., gas, gel, liquid, solid, etc. In certain embodiments, the composition is a gas or mixture of gases.

As used herein, in connection with a combustible gas, the term “ignited” or “ignitable” or “ignited” refers to a gas which has undergone combustion or the process by which a gas undergoes combustion.

As used herein, the terms “infuse” or “infusion” or “infusing” or any variation thereof encompasses any other suitable method of mixing reducing gas or silicate with liquid, such as injecting, administering, or applying. In some embodiments, a process is provided for preparing a stable, non-toxic, non-corrosive reducing liquid by infusing a gas produced by the electrolytic process described herein into a “source liquid” to be treated using described processes. The source liquid can be any suitable liquid that can stably incorporate an infused reducing gas. Examples of suitable source liquids include, but are not limited to, organic solvents, nonpolar oils, mineral oils, essential oils, colloidal suspensions, colloidal solutions, leachates from landfills, polychlorinated byphenols (PCBs), and aqueous compositions. In preferred embodiments, the source liquid for infusion is water to be used to prepare cell culture media. Sources of water include for example, distilled water, deionized water, tap water, potable water, potable beverages, nonpotable water, agricultural water, irrigation water, salt water, brackish water, fracking waters, water having aqueous heavy metals dissolved therein, industrial water, recycled water, fresh water, water from a natural source, or reverse osmosis water. Potable water is understood to be water safe for human or animal consumption; non-potable water is not safe for human or animal consumption but can be used in other applications. Fresh water is understood to be water from a natural source that is not salt water. Salt water may be from a natural source such a sea or ocean, it also includes man-made salt water. Industrial water is water that is a used in industrial applications such as manufacturing processes, washing of containers, machines, etc. Industrial water may be tap water, well water, etc. that is typically non-potable water.

As used herein, “restructuring” refers to a process for transforming a liquid into a reducing liquid or a gas into a reducing gas. As used herein, “restructured liquid” or “reducing liquid” refers to a liquid which has undergone restructuring. A reducing liquid is used to prepare a preservative composition described herein, which may be subsequently used to treat an exhaust stack in certain embodiments of the present invention.

As used herein, the terms “stack” or “exhaust stack” refer to an outlet for exhaust which results from a combustion reaction. In typical embodiments, without limitation, a stack mentioned in the present disclosure is generally of a tubular shape or structure and can be of any size. A stack can be associated with any source of exhaust or any source of a combustion reaction (e.g., combustion of fossil fuels, hydrocarbons, or other combustible materials or substances).

As used herein, the term “substantially free” refers to quantities of less than about 1%, preferably less than about 0.1% for the indicated matter.

As used herein, the terms “treating” or “treatment” (and grammatical variations thereof) refer to the practicing or implementation of a method described herein that partially or completely alleviates, ameliorates, relieves, inhibits, delays onset of, reduces severity of, and/or reduces or otherwise lowers the amount of pollution produced by a process such as, for example and without limitation, a combustion reaction. In certain embodiments, the amount of pollution may be measured as a total number of particulate species present in a gaseous product or byproduct of a process such as, for example and without limitation, an industrial process and/or a combustion reaction. For example, the total amount of pollution may be described in terms of parts per hundred or percent of an air sample, or parts per thousand (ppt), parts per million (ppm), parts per billion (ppb), parts per trillion (ppt), and so on.

### EMBODIMENTS

The present disclosure provides methods, compositions, and systems for decomposing particulate pollutants in an exhaust source. In certain exemplary embodiments, the compositions, systems, and methods disclosed herein are based on the injection of, or other means of introducing, a highly reducing, negatively charged gas such as “Hydrogas™” along with one or more combustible gases into an exhaust stack by one or more nozzles.

In one aspect, the present disclosure provides a method for decomposing particulate pollutants in an exhaust source.

In one embodiment, the method comprises: (i) injecting, via a first series of nozzles, a reducing gas into the exhaust source containing the particulate pollutants; (ii) injecting, via the first series of nozzles or a second series of nozzles, a combustible gas; and (iii) igniting the combustible gas in the presence of the reducing gas, thereby decomposing the particulate pollutants.

In another embodiment, the method comprises: (i) infusing a liquid with a reducing gas and a metasilicate, wherein the infusing involves mixing under turbulent conditions, wherein the reducing gas and/or the metasilicate reacts with the aqueous solution to produce a reducing liquid having the oxidation reduction potential (ORP) value of about −100 mV or more negative; (ii) injecting or spraying, via a first series of nozzles, the reducing liquid into the exhaust source comprising the particulate pollutants; (iii) injecting, via the first series of nozzles or a second series of nozzles, a combustible gas into the exhaust source; and (iv) igniting the combustible gas in the presence of the reducing liquid, thereby decomposing the particulate pollutants.

In some embodiments, the first and/or second series of nozzles is provided in a circular ring arrangement. In some embodiments, the first and/or second series of nozzles is provided in a spiral or helical arrangement.

In the methods, compositions and systems of the present disclosure, a combustible gas is used in combination with the reducing fluid, such as a reducing liquid.

As used herein, the term “reducing fluid” may be used with reference to a reducing substance that can flow, such as a reducing gas, reducing plasma or reducing liquid. A reducing fluid carries electrons and can be oxidized when losing the electrons. These terms should be interpreted as being interchangeable with one another, unless the context indicates otherwise. In some embodiments, the reducing fluid is a reducing gas. In some embodiments, the reducing gas is Hydrogas™, oxyhydrogen (Knell gas), Brown's Gas, Tylar Gas, or HHO Gas (Klein Gas).

In some embodiments, the reducing fluid is a reducing liquid. It is reported herein that the electrolytic process described herein releases free electrical charge via the water-based reducing gas and, optionally, the liquid metasilicate and its reducing, high alkaline, non-caustic, and nontoxic properties. In certain embodiments, a reducing gas described herein may be used to infuse a liquid to obtain a reducing liquid (a highly reducing, high alkaline liquid, for example). In such embodiments, the liquid may be injected, sprayed, aerosolized, or otherwise applied within an exhaust stack along with one or more combustible gases, whereby, upon or following ignition, said ignition results in the decomposition of particulate pollutants in emitted exhaust. In some embodiments, the reducing liquid is produced by infusing a liquid with a reducing gas and a metasilicate, wherein the infusing involves mixing under turbulent conditions, wherein the reducing gas and/or the metasilicate reacts with the aqueous solution.

In some embodiments, the reducing gas may comprise a highly reducing, negatively charged gas such as “Hydrogas™”. In some embodiments, the reducing liquid disclosed herein may comprise a highly reducing, high alkaline liquid (e.g., a highly reducing, negative ORP or “HRNORP”) or powder, such as reformed sodium metasilicate (RLS). The RLS according to the present invention may be formed with any liquid (e.g., any HRNORP liquid). The highly reducing gas for infusing the liquid may be any highly reducing, negatively charged gas, including but not limited to such gases as Hydrogas™ HHO, BROWNS Gas, Tylar Gas, Knell Gas, etc.

In certain embodiments, a reducing gas (e.g., Hydrogas™) is introduced into the exhaust stack at ambient temperature (i.e., the temperature of the exhaust stack without any additional heat being applied). Additionally, one or more combustible gases is/are introduced into the exhaust stack. Upon ignition of the mixture of reducing fluid and combustible gas, particulate pollutants in the exhaust will undergo decomposition to form inert, non-polluting products.

In certain embodiments, the combustible gas is an alkane, such as methane, ethene, propane, butane, or pentane. In other embodiments, the combustible gas may be hydrogen or oxygen. In other embodiments, the combustible gas is propane (e.g., liquid propane gas or “LPG”) and/or natural gas.

One of ordinary skill will appreciate that the amounts of reducing fluid and combustible gas(es) may be adjusted up or down based on the size of the exhaust stack and/or the amount of exhaust emitted by the exhaust stack.

In some embodiments, the reducing gas and combustible gas are introduced into an exhaust stack and then heated together to a temperature in the range of about 400-700° Fahrenheit (F), or 420-680° F., or 430-670° F., or 440-660° F., or 450-650° F.

In certain embodiments, the reducing gas and combustible gas are heated together to a temperature of at least about 454° F. In certain embodiments, the reducing gas and combustible gas are heated together to a temperature of at most about 610° F.

In some embodiments, the combustible gas is introduced before the reducing gas. In other embodiments, the combustible gas is introduced after the reducing gas.

In some embodiments, the combustible gas is ignited by introducing an ignition source, such as a flame, into the exhaust stack. In some embodiments, the combustible gas is ignited by actuating the ignition source (e.g., turning on a heat switch). Ignition of the combustible gas and reducing gas may be achieved by increasing the temperature of the exhaust stack. In some embodiments, the combustible gas is ignited by heating the chamber in the exhaust stack to a temperature of at least 454 degrees Fahrenheit. In other embodiments, ignition may involve one or more catalysts.

In certain embodiments, following treatment by the method disclosed herein, exhaust from a stack contains about 90% or less particulate pollutants, or about 80% or less particulate pollutants, or about 70% or less particulate pollutants, or about 60% or less particulate pollutants, or about 50% or less particulate pollutants, or about 40% or less particulate pollutants, or about 30% or less particulate pollutants, or about 20% or less particulate pollutants, or about 10% or less particulate pollutants as compared to the exhaust prior to being treated by the present method or in the absence of the present method.

In some embodiments, following treatment by the method disclosed herein, the exhaust exiting the exhaust stack contains about 50% or less of the particulate pollutants as compared to the exhaust prior to being treated by the present method or in the absence of the present method. In some embodiments, following ignition of the combustible gas in the presence of the reducing gas, the exhaust exiting the exhaust stack contains about 70% or less of the particulate pollutants as compared to the exhaust prior to being treated by the present method or in the absence of the present method.

In certain embodiments, the method disclosed herein decomposes at least 10%, or by at least 20%, or by at least 30%, or by at least 40%, or by at least 50%, or by at least 60%, or by at least 70%, or by at least 80%, or by at least 90% of the particulate pollutants that would otherwise be present in an exhaust stack (as measured, for example, by comparing the amount of particulate pollutants present before and after the method).

As used herein, “particulate pollutants” or “particulate matter” or other concepts described as “particulate” refer to contents of exhaust which are of an average diameter of 50 nm or more, unless otherwise stated.

In certain embodiments, the minimum average diameter of particulate pollutants to be removed from an exhaust gas is about 50 nm, unless otherwise stated. In certain embodiments, the maximum average diameter of particulate pollutants to be removed from an exhaust gas is about 2.5 μm, unless otherwise stated.

In certain embodiments, the exhaust emitted from a stack which incorporates a system or chamber described herein (e.g., a heating chamber or plug-and-play stack) or in which a method described herein is implemented, is essentially free of particulate pollutants having an average diameter of about 1.0 μm or more.

In other embodiments, the exhaust emitted from the stack is substantially or essentially free of particulate pollutants having an average diameter of about 500 nm or more.

In other embodiments, the exhaust emitted from the stack is substantially or essentially free of particulate pollutants having an average diameter of about 250 nm or more.

In other embodiments, the exhaust emitted from the stack is substantially or essentially free of particulate pollutants having an average diameter of about 100 nm or more.

In other embodiments, the exhaust emitted from the stack is substantially or essentially free of particulate pollutants having an average diameter of about 50 nm or more.

An exhaust stack of the present disclosure may be associated with or in communication with any source of exhaust or any source of a combustion reaction (e.g., combustion of fossil fuels, hydrocarbons, or other combustible materials or substances). For example, and without limitation, references to an exhaust stack may be made with reference to exhaust stacks provided at or on manufacturing plants (e.g., factories), vehicles (e.g., ships, boats, trucks, cars, SUVs, etc.), power plants, refineries, smelting plants, and heavy machinery/equipment (e.g., construction equipment, excavation equipment, etc.), among other sources of combustion exhaust. For example, a stack or exhaust stack may encompass a flue-gas stack, also known as a smokestacks or chimney stack, a stack which offputs exhaust from trucks, ships/barges, encompasses well as exhaust stacks on the tailpipes of cars, SUVs, trucks, motorcycles, etc.

In some embodiments, the exhaust stack is in communication with a manufacturing plant. In other embodiments, the exhaust stack is in communication with a vehicle.

Also provided herein are embodiments of a heating chamber or stack which may be added to an existing stack or system. A heating chamber, stack or system described herein comprises at least one nozzle, optionally a plurality of nozzles configured to introduce a reducing gas or reducing liquid and a combustible gas.

In certain embodiments, the same nozzle may introduce both the reducing gas/liquid and the combustible gas. In such embodiments, the nozzle may be configured to introduce the reducing gas/liquid and the combustible gas in a single stream. In other embodiments, the nozzle is configured to introduce the reducing gas/liquid in a first stream and the combustible gas in a second stream. In yet other embodiments, the nozzle is configured to introduce the combustible gas in a first stream and the reducing gas/liquid in a second stream.

In other embodiments, each nozzle is configured to introduce either the reducing gas/liquid or the combustible gas. In other words, certain nozzles may be configured to introduce only the reducing gas/liquid, whereas other nozzles may be configured to introduce only the combustible gas.

The heating chamber or stack described herein is also configured to be heated gradually up to a temperature necessary to ignite the combustible gas and reducing gas/liquid mixture (i.e., to cause combustion of the combustible gas).

Alternatively, the heating chamber or stack described herein may be configured to introduce an ignition source such as a flame to ignite the combustible gas and reducing gas/liquid mixture.

A heating chamber or stack of the present invention is not limited in size and may be scaled up or down as appropriate for compatibility with an existing stack.

In certain embodiments, a heating chamber or stack described herein is part of a modular system which permits the swapping (i.e., “plug-and-play”) of different modules, wherein the heating chamber or stack comprising one or more nozzles is one such module.

For example, in some embodiments, a heating chamber or stack of the present invention is sized and configured to be attached or otherwise incorporated into a stack used by or incorporated into an industrial facility, such as a manufacturing plant, power plant, or other large-scale structure which offputs exhaust containing pollutants.

In other embodiments, a heating chamber or stack of the present invention may be sized and configured to be attached or otherwise incorporated into a stack attached to a mode of transportation, such as a cargo ship or other marine vessel, a freight train or passenger train, or a truck (e.g., a semi-truck) or construction equipment (e.g., a dump truck) or heavy machinery such as land-moving equipment (e.g., excavators and the like).

In yet other embodiments, the heating chamber or stack of the present invention may be sized and configured to be attached or otherwise incorporated into a stack attached to a mode of transportation intended for consumers, such as a tailpipe on a car, sport utility vehicle (SUV), or motorcycle.

In some embodiments, the heating chamber or stack of the present invention may be sized and configured to be attached or otherwise incorporated into a stack provided on or incorporated into a boat, plane, or other mode of transportation.

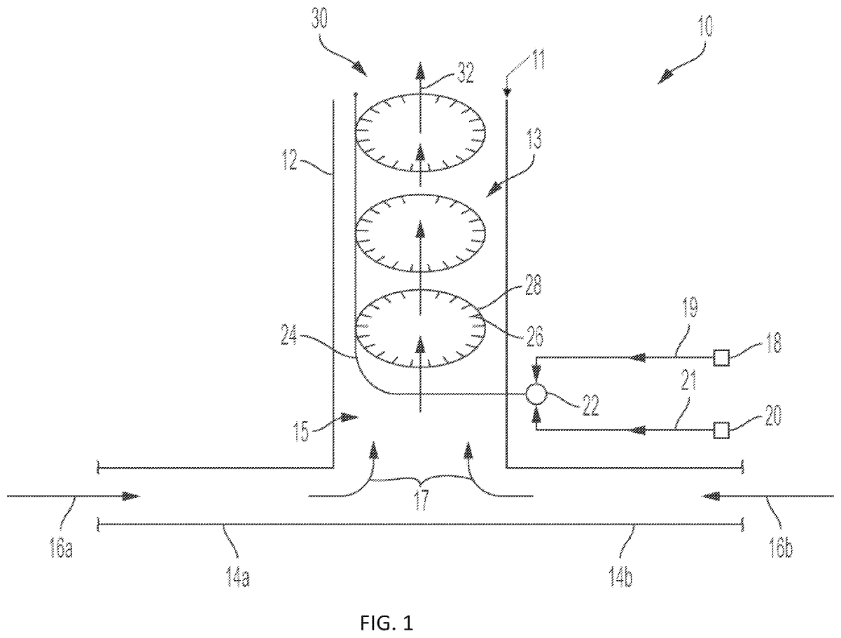

FIG. 1 shows a diagrammatic representation of an exemplary system 10 for decomposing particulate pollutants according to the present disclosure. FIG. 1 illustrates an exemplary system 10 comprising a plurality of nozzles 26, each configured to inject a stream of reducing fluid 19 and/or a stream of combustible gas 21 into a chamber 13 within an exhaust stack 12. In FIG. 1, the plurality of nozzles 26 are linked to a fluid exit line 24 receiving a stream of reducing fluid from a reducing fluid injection line 19 connectively linked to a fluid injection source 18 and a stream of combustible gas from combustible gas injection line 21 connectively linked to a combustible gas source 20.

The system 10 further includes a heating source or ignition source 15 in communication with the chamber 13 or exhaust stack 12 to ignite the combustible gas in the presence of the reducing fluid to decompose the particulate pollutants in the pollutant gases 17. In some embodiments, the pollutant gases 17 flow from one or more pipes 14a, 14b feeding into the chamber 13, the pipes 14a, 14b receiving the pollutant gases 17 from one or more exhaust sources 16a, 16b. Upon decomposition of the particulate pollutants in the chamber 13, a stream of decomposed particulates 32 flows out of the chamber 13 or exhaust stack 12 through a distal outlet 30.

FIG. 1 further shows a mixer 22 wherein reducing fluid from a reducing fluid injection line 19 is mixed with combustible gas from a combustible gas injection line 21 and then passed together through a single fluid exit line 24. Alternatively, the streams of reducing fluid 19 and combustible gas 21 may feed directly into a fluid exit line 24 without a mixer 22. Thus, in some embodiments, each of the plurality of nozzles 26 in the system 10 inject or spray into the chamber 13 a mixture of reducing fluid and combustible gas via a single fluid exit line 24, wherein the reducing fluid flows into the single fluid exit line 24 via a reducing fluid injection line 19 and the combustible gas flows into the single fluid exit line 24 via a combustible gas injection line 21.

In other embodiments, each stream of reducing fluid and combustible gas from the reducing fluid injection line 19 and combustible gas injection line 21 is separately linked to a corresponding reducing fluid exit line 24a or a combustible gas exit line 24b, each separately feeding into the plurality of nozzles 26 such that a corresponding nozzle 26 injects either the reducing fluid 19 or the combustible gas 21 (but not both) into the chamber 13 of the stack 12 (not shown). Thus, in some embodiments, each of the plurality of nozzles 26 in the system 10 injects or sprays into the chamber 13 of the exhaust stack 12 a reducing fluid from a reducing fluid exit line 24a and a combustible gas from a combustible gas exit line 24b, wherein each of the reducing fluid exit line 24a and the combustible gas exit line 24b separately feeds into the plurality of nozzles 26 via separate fluid exit lines 24a, 24b.

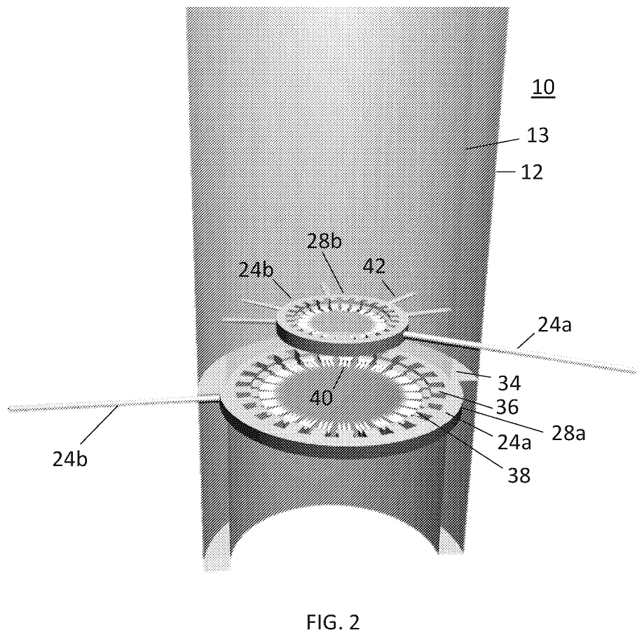

In some embodiments, the plurality of nozzles 26 is circularly arranged in the form of rings positioned around the interior wall 11 of the exhaust stack 12. For example, in FIG. 1, the system includes two fluid exit lines 24 forming rings 28 linked to a plurality of nozzles 26, whereby the fluid exit line 24 is configured to form, for example, three horizontally arranged rings 28 laterally encircling and longitudinally centered within the chamber 13, as exemplified in FIG. 2. Any number of rings 28 may be employed in a system 10 according to the present disclosure.

In one exemplary embodiment shown in FIG. 2, a system 10 for decomposing particulate pollutants includes a chamber 13 in an exhaust stack 12 comprising a combustible fluid exit line 24a and a reducing fluid exit lines 24b, each optionally encased or supported by horizontally arranged support ring 28a, 28b, respectively. As shown in FIG. 2, the outer periphery of ring 28a is directly linked to the interior wall 11 of the exhaust stack 12 and receives combustible gas through a combustible gas injection line 44. Ring 28b is connectively linked to the wall 11 of the exhaust stack by a plurality of spokes 42 and receives a reducing fluid from a reducing fluid injection line 46. The nozzles 26 are connected to fluid exit lines 24a, 24b in rings 28a, 28a by a series of connectors 36. FIG. 2 shows an embodiment in which triplets of nozzles 26 are linked to the combustion gas exit line 24a in ring 28a and to the reducing fluid exit line 24b in ring 28b by a connector 36. Each nozzle 26 emits a combustible gas or reducing fluid as a fluid stream 40. The number, arrangement and order of the combustion gas exit 24a and reducing fluid exit line 24b may vary within the chamber 13 of the stack 12. Upon ignition of the combustible gas in the presence of the reducing fluid, particulate pollutants in the chamber 13 of the stack 12 are decomposed.

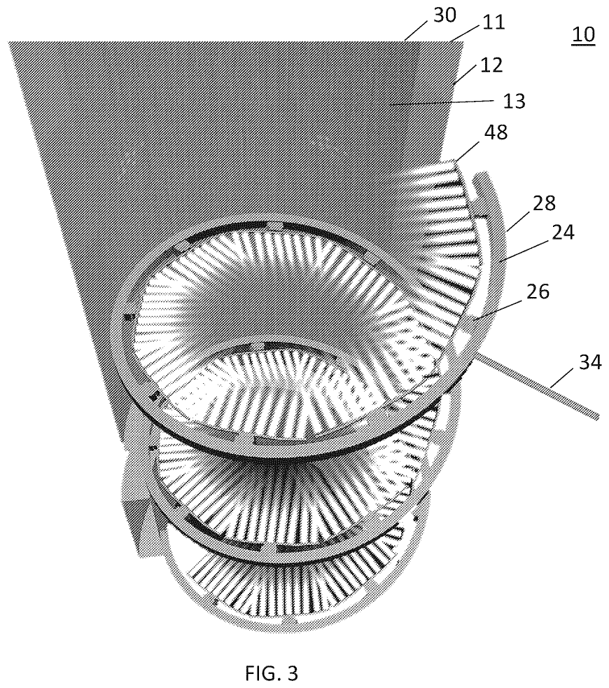

In another exemplary embodiment depicted in FIG. 3, a system 10 for decomposing particulate pollutants includes a chamber 13 in a stack 12 wherein a fluid exit line 24 is spirally or helically wound around the chamber 13 of an exhaust stack in a vertical direction and the fluid exit line 24 is connectively linked to a plurality of nozzles 26 receiving fluids (e.g., reducing fluid and/or combustible gas) from the fluid exit line 24. The nozzles 26 are configured to inject, spray or otherwise release multiple streams of reducing fluids, combustible gases, or mixtures thereof into the chamber 13 from a rectangular vessel 48 linked the nozzle 26 as shown. In certain embodiments, the fluid exit line 24 is encased in or supported by a spirally or helically wound support member 28 connectively linked to the wall 11 of the exhaust stack 12. FIG. 3 shows an exemplary embodiment, where the fluid exit line 24 receives the reducing fluid and/or combustible gas from a fluid injection line 34. In certain embodiments, a plurality of fluid injection lines 34 may be connected to the fluid exit line 24 to allow for separate or mixed flows of the reducing fluid and combustible gas into the fluid exit line 24. As shown in FIG. 3, the radius of the spirally or helically wound fluid exit line 24 changes in a longitudinal direction. From one end to the other, the radius may increase or decrease by at least 10%, at least 20%, at least 30%, at least 40%, at least 50%, at least 60%, at least 70%, at least 80%, at least 90%, at least 2-fold, at least 5-fold, at least 10-fold, at least 20-fold or at least 50-fold or more, or any % radius range thereof. Alternatively, the spirally or helically wound fluid exit line 24 may have a constant radius from one end to the other.

In other embodiments, the nozzles 26 may be longitudinally arranged along discrete wall 11 sections of the exhaust stack 12. In yet other embodiments, the nozzles 26 may be longitudinally arranged around one or more circumferential portions of the wall 11 or circumferentially arranged around the wall in its entirety.

Described in detail below is an exemplary method of preparing a reducing gas and/or a reducing liquid for use in the method of the present invention.

The process for preparing a reducing gas may comprise preparing an activator, wherein the activator comprises water, potassium hydrate, magnesium sulfate, sodium oxidanide, and an alkaline metal silicate; introducing the activator into a reaction chamber of a reactor, wherein the reactor is configured to produce an electrolytic reaction; adding water to the reaction chamber to provide a water-activator mixture; and applying a direct current in the water-activator mixture to produce the reducing gas. It is generally desirable that the pressure in the reaction chamber is reduced to increase the rate of production of the reducing gas. In a preferred embodiment, the reducing pressure in the reaction chamber is maintained at about 0.5 bar. The reactor chamber typically comprises a wet electrolytic cell to propel the electrolytic reduction process as described herein. Additional information may be found in WO2019/232387, the relevant disclosures of which are incorporated by references for the subject matter and purpose referenced herein.

The activator may be prepared using any suitable equipment for conducting chemical reactions involving the activator reagents. Typically, the activator is prepared by combining the activator components in balanced stoichiometric amounts from the oxidation-reduction equation. In some embodiments, the activator comprises potassium hydrate, magnesium sulfate, sodium oxidanide, and an alkaline metal silicate in a predetermined stoichiometric ratio. The activator can comprise about 40 wt % to about 59 wt % potassium hydrate; about 0.1 wt % to about 5 wt % magnesium sulfate; about 40 wt % to about 59 wt % sodium oxidanide; and about 0.1% to about 5 wt % alkaline metal silicate. In other embodiments, the activator can comprise about 45 wt % to about 55 wt % potassium hydrate; about 0.2 wt % to about 3 wt % magnesium sulfate; about 45 wt % to about 55 wt % sodium oxidanide; and about 0.2% to about 3 wt % alkaline metal silicate. In other embodiments, the activator can comprise about 47 wt % to about 53 wt % potassium hydrate; about 0.2 wt % to about 1.5 wt % magnesium sulfate; about 47 wt % to about 53 wt % sodium oxidanide; and about 0.2% to about 1.5 wt % alkaline metal silicate. In other embodiments, the activator can comprise about 48 wt % to about 51 wt % potassium hydrate; about 0.3 wt % to about 0.8 wt % magnesium sulfate; about 48 wt % to about 51 wt % sodium oxidanide; and about 0.3% to about 0.8 wt % alkaline metal silicate. Potassium hydrate, magnesium sulfate, and sodium oxidanide are commercially available. In other embodiments, the activator is a liquid solution comprising potassium hydrate, magnesium sulfate, sodium oxidanide, and an alkaline metal silicate in any of the stoichiometric amounts described herein. The liquid solution can have an activator concentration of about 0.1 to about 20 g/l, about 0.1 to about 15 g/l, about 0.1 to about 10 g/l, about 0.1 to about 5 g/l, about 0.5 to about 4 g/l, about 0.5 to about 3 g/l, about 1 to about 3 g/l, or about 1.5 to about 2.5 g/l.

The activator can be prepared by any suitable method. For example, the potassium hydrate, sodium oxidanide, alkaline cationic silicate, and magnesium sulfate can be measured out in any of the weight ratios described herein, and subsequently combined to form a single activator mixture. This activator mixture can then be dissolved into water at a predetermined concentration as described hereinabove. Alternatively, a quantity of water can be provided, and the potassium hydrate, sodium oxidanide, alkaline cationic silicate, and magnesium sulfate can be added to the quantity of water in sequence, simultaneously, or combined pairs. In some embodiments, the magnesium sulfate and the alkaline cationic silicate are first mixed into the quantity of water, and the potassium hydrate and sodium oxidanide are subsequently mixed into the quantity of water. Preparation of the activator can be carried out external to a reactor and subsequently added in. Alternatively, the activator can be prepared in a reaction chamber of a reactor. Preferably, the alkaline cationic silicate is a metasilicate such as an alkaline sodium silicate complex (SSC) or reformed liquid silica (RLS). The metasilicate can be used in the preparation of an activator and may optionally be added in greater quantities with or without the reducing gas into the source liquid. These complexes are described, for example, in US 20110059189A1, which is incorporated herein by reference. Mass spectroscopic (MS) and nuclear magnetic resonance (NMR) analysis generated a putative empirical formula of the compound or complex to be Na8.2Si4.4H9.70i7.6. The formula suggests that alkaline sodium silicate complex (SSC) is not a single compound but a mixture of two different compounds that are in equilibrium with each other. Specifically, the SSC is a mixture of trimeric sodium silicate (Na₂Si0₃)₃, Na Na⁴ Na⁴:

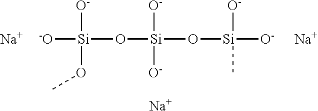

and Sodium Silicate Pentahydrate (Na₂SiO₃) 5H₂O.

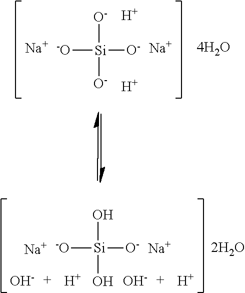

Sodium silicate pentahydrate (Na₂SiO₃) 5H2O typically exists in equilibrium as two structural forms, with one form containing one ionized water molecule and the other form containing 3 ionized water molecules. To produce SSC, silicon metal (any grade) is loaded into a reactor. Sodium oxidanide is added along with water. An exothermic reaction occurs. The reaction is allowed to proceed for 4-6 hours, after which the product is collected in a cooling tank. The product is cooled, and the obtained liquid product is packaged.

The silicon-based alkaline composition (empirical formula of Na8.2Si4.4H_{9.7}0i7.6) can have a specific density in the range of 1.24 to 1.26 kg/m³, for example, 1.25±0.1 kg/m³. The composition can also have a pH in the range of 13.8 to 14.0, for example, 13.9±0.1. In some embodiments, the SSC can be dried via any suitable method prior to use in any of the processes described herein. Suitable drying methods include, but are not limited to, mild heating, storage in a desiccator, vacuum drying.

SSC physiochemical properties and potential therapeutic applications have been previously studied. In one study, SSC was found to exhibit antimicrobial properties for gram positive, gram negative, and drug resistant strains as described, for example, in Vatten et al., Res. J. Microbiol. 2012 Mar. 1; 7(3): 191-8. Sodium silicate is also generally recognized as safe for human consumption by the US FDA pursuant to 21 C.F.R. § 182.90. US 20140087003A1 describes a method using an alkaline sodium silicate composition to inhibit the toxic effects of venom and treat venomous bites and stings. US 20060275505A1 describes a composition for increasing alkalinity in the body containing water, a source of alkalinity, particularly an alkaline silicon solution. US20110059189A1 describes a modified sodium silicate composition, and methods of treating cancer and viral infections utilizing the modified sodium silicate composition (Na_{8.2}Si_{4.4}H_{9.7}0i_{7.6}), also described in Townsend et al., Int. J. Appl. Res. Nat. Prod. 2010; 3:19-28 (AVAH silicates were also effective in inhibiting several important physiological events important in survival and development of virulence in viral and microbial pathogens). However, the SSC referenced in those publications did not involve a reducing gas, the combination of which is a subject under this description, along with other beneficial uses of this technology.

The electrolytic process is generally carried out in a reactor. In an exemplary process, the activator is either prepared within a reaction chamber of the reactor or externally prepared and subsequently added to the reaction chamber. Additional water can be combined with the activator in the reaction chamber in any suitable quantity, including up to the fill capacity of the reaction chamber.

The reactor can be any suitable apparatus for carrying out an electrolytic reaction. In some embodiments, the reactor comprises a wet electrolytic cell. In an electrolytic cell, an electric current is passed from an electronic conductor through a chemical substrate such as an ionic solution contained in one or more cells (i.e., reaction chamber), back into a second electronic conductor. The circuit is closed outside (external circuit) of the cell through various electronic conductors. This typically includes a power supply and a current measuring device. The junctions between the electronic and ionic conductors are called electrodes, namely cathodes and anodes. In the electrolysis reaction, a direct current is passed through the solution contained in the reaction chamber, producing chemical reactions at the electrodes. In a standard electrolysis of pure water (i.e., without activator present), a reduction half reaction occurs at the cathode in which electrons from the cathode are transferred to hydrogen cations to form H₂ gas as illustrated by the chemical equation: 2 H+(aq)+2e H₂(g). At the anode, an oxidation half reaction occurs in which electrons are transferred from water molecules to the anode to form 0₂ gas as illustrated by the chemical equation: 2 H₂0(l) 0₂(g)+4 H⁺(aq)+4e⁻. These half reactions can be balanced with the addition of base.

A direct current (DC) electrical supply is coupled to the reactor and provides the energy necessary to drive the electrolytic process. Electric current is carried by electrons in the external circuit. Electrodes of metal, graphite and semiconductor material are widely used. Choice of suitable electrode depends on chemical reactivity between the electrode and electrolyte and manufacturing cost. A DC electrical power source is connected to two electrodes, or two plates (typically made from some inert metal such as platinum, stainless steel 360 or iridium) which are placed in the water. In some embodiments, the DC delivered to the electrolytic cell is in the range of about 20 V to about 30 V, for example about 24.65 V±0.12 V. The input of electrical current can be further be through a 110 V (60 Hz) or 220 V, 50 Hz or 60 Hz circuit.

The reactor can be configured to perform the electrolytic reaction under reduced pressure or in a vacuum. Vacuum-electrolysis reactors are known in the art and suitable apparatuses will be readily apparent to a person of ordinary skill. The electrolysis reaction can be conducted at standard temperature and pressure (STP). In some embodiments, the reaction is initially conducted at STP, then subsequently, once the production of reducing gas begins inside the reactor chamber, the pressure can be reduced inside the reaction chamber. For example, the reduced pressure can be about 0.3 bar to about 0.9 bar. In some embodiments, the reduced pressure is 0.5±0.05 bar. By performing the reaction under reduced pressure, the rate of production of the reducing gas can be increased by up to 2.2-fold over the reaction performed at standard atmospheric pressure.

In some embodiments, the liquid can be an aqueous solution having medium to high biochemical oxygen demand (BOD). BOD is defined as the amount of dissolved oxygen needed by aerobic biological organisms to break down organic material present in a given water sample, most commonly expressed in milligrams of oxygen consumed per liter of sample during 5 days of incubation at 20° C. In some embodiments, the aqueous solution has a 5-day BOD in the range of about 2 mg/F to about 600 mg/F. In certain preferred embodiments, the liquid is water, optionally deionized or distilled water.

Infusion can be conducted by any suitable method. For example, the gas can be infused into the liquid by bubbling the reducing gas into the liquid. The bubbling can be conducted simultaneously with electrolytic production of the reducing gas by coupling the reactor to a container having the liquid therein and flowing the reducing gas into the liquid as it is produced. Alternatively, the infusion can be conducted by bubbling a stored reducing gas, such as in a pressurized gas tank, into a container having the liquid therein.

The infusion process can be augmented by adding the reducing gas to the liquid under turbulent conditions. In fluid dynamics, turbulence or turbulent flow is any pattern of fluid motion characterized by chaotic changes in pressure and flow velocity. Turbulence is caused by excessive kinetic energy in parts of a fluid flow, which overcomes the damping effect of the fluid's viscosity. In general terms, in turbulent flow, unsteady vortices appear of many sizes which interact with each other. Turbulent conditions can be created by a variety of methods that are well-known, which include, but are not limited to, vortexing, shaking, vibrating, mixing, flotation, and cavitation. Turbulence and cavitation improve dissolution rate of the reducing gas into the liquid by up to 100-fold, depending on the application and on the flow capacity of the recirculating pump, typically measured in volume units (e.g., gallons, liters) per minute. In some embodiments, the turbulent conditions are produced by cavitation, wherein the cavitation is conducted using a propeller, impeller, or suitable device. In one example, a recirculating pump is used that contains an impeller, at a rate of up to 3600 revolutions per minute (RPM), preferably 750-900 RPM. Venturi technology is also used when the turbulence is created inside pipes that have a positive flow pressure of liquids.

In producing the stable reducing liquid, the reducing gas is infused into the liquid until a threshold negative ORP is achieved and observed for a sufficient amount of time (stabilization or retention time) to reliably measure the ORP value using a commercially available and calibrated ORP meter with a waterproof electrode, preferably one that can also measure pH. A person of ordinary skill in the art will understand the routine conventions associated with the measurement of reduction potentials, including standard oxidation reduction potentials. This stabilization time will vary depending on the amount of liquid produced per unit of time. In some embodiments, the stabilization time is at least about 2 minutes. In other embodiments, the stabilization time is at least about 10 minutes. More generally, the stabilization time will vary from a few seconds to 28 hours, depending on several factors including the degree of chemical oxygen demand (COD) and the presence or absence of colloidal particulates, oils, solvents and/or others dissolved solutions. Reduced pressure and turbulence will improve the efficiency and thus will reduce the retention time by up to a factor of 100. Appropriate methods for the determination of the appropriate stabilization time for a liquid sample of interest are within the technical knowhow of a person of ordinary skill in the art. The induction of reduced pressure and turbulence will also allow the generation of a “residual effect” in many cases. For example, by applying the correct stabilization time, the infused liquid will maintain a reducing and disinfecting residual effect (i.e., replacing oxidants like chlorine, ozone, UV, H₂O₂, etc.). In some embodiments, the threshold ORP after stabilization is −150 mV or more negative.

A composite reducing liquid comprising a nontoxic, non-corrosive reducing agent and the infused reducing liquid described herein can also be prepared. The nontoxic, non-corrosive reducing agent can be any compound that is readily miscible with the infused reducing liquid. Suitable reducing agents include, but are not limited to, natural antioxidants for example, ascorbic acid (vitamin c), glutathione, melatonin, and water-soluble tocopherols (vitamin E). In some embodiments, the non-toxic, non-corrosive reducing agent is an alkaline cationic silicate as described herein. The composite reducing liquid can be produced by any suitable method. In some embodiments, the non-toxic, non-corrosive reducing agent is added in a predetermined quantity to an infused reducing liquid. In other embodiments, the reducing agent and the reducing gas are simultaneously infused into a liquid. This simultaneous infusion can be conducted under turbulent conditions, such as using a recirculating pump at a rate of at least about 800±35 RPM.

The addition can be conducted by quantitative transfer of a single aliquot into the infused reducing liquid. Alternatively, the addition can be conducted by a continuous transfer of the reducing agent from a storage vessel at any desired flow rate over a specific period of time. The flow rate(s) and time will depend on the reducing agent and the desired stoichiometric ratio of reducing agent to infused reducing liquid in the composite reducing liquid. In another embodiment, the reducing agent is added in a punctuated, drop-wise fashion comprising multiple aliquots.

In some embodiments of the process for producing an aqueous reducing liquid, the infusion step of reducing gas, previously described, is performed by infusing 75 to 120 liters per minute of reducing gas per every 60 gallons per minute of the liquid to be restructured, prior to or simultaneously with the alkaline cationic silicate in the range of 0.5 to 12 milligrams per liter. In other embodiments, the quantity of the alkaline cationic silicate required in the process step is in amounts described herein-above, wherein the alkaline cationic silicate comprising of lithium silicate, sodium silicate, potassium silicate, ammonium silicate, or a combination thereof.

In one aspect, the process for preparing a reducing liquid comprising infusing a reducing gas (e.g., a reducing gas produced by an electrolytic process described herein) into a quantity of liquid under turbulent conditions. Inducing turbulence and cavitation in this process increases the efficiency of restructuring the water in the tank up to a thousand-fold. It allows for the use of 1 kw of power per every ten thousand (10,000) gallons of water to be restructured per hour. Without the implementation of the cavitation/turbulence system, the rate of dissolution of gas with liquid is inefficient for utility. However, the upper limit for turbulent conditions in this process is less than 3600 RPM because excessive turbulence leads potential cavitation of the impeller of the water pump, which is undesirable for utility.

In some embodiments, the restructuring process comprises the following steps: reducing water gas (“Cl”) and reducing liquid metasilicate (“C2”) are injected immediately before the source liquid enters a conventional reservoir or container. The source liquid to be treated may go through (i) a closed pressured pipe; or (ii) an open water tank, channel, or open pipe under atmospheric conditions or normal temperature and pressure conditions.

If the source liquid to be treated goes through a closed pressurized pipe, the following steps are further performed: (i) Cl and C2 are injected to the pipe, where Cl is injected via a Venturi apparatus or via another method of creating negative pressure in the pipe; (ii) C2 is proportionally injected via conventional dosing pumps, gravitational dosing methods, or any other method used to dosify liquid chemicals. Negative pressure improves the production of the liquid. Depending on the electrolytic cell, the improvement of gas production can be up to 250%. Different tests conducted show with accuracy that it takes about 9325 liters of Cl gas under NPT conditions to restructure, in about 10 hours, 5000 gallons of water to be treated. This value is equivalent to 932.5 liters of Cl per hour without using enhancing methods of cavitation. The flow of reducing gas (Cl) is then measured as flow in liters per hour (FLPH) using a formula that varies depending on the source liquid and other parameters, described further herein for each source liquid and corresponding use. Once the closed pressurized system is stabilized, The ORP value is measured in millivolts (mv). The ORP will vary depending on the composition of the source liquid. The minimum contact time of Cl with the source liquid required inside the pipe is typically between 3 seconds and 30 minutes. The ORP charge is measured after at least 3 seconds of minimum contact time of Cl with the source liquid and should result in a negative value. The formula for calculating FLPH is irrelevant of the liquid pressure inside the pressurized pipe. The volume (milliliters) of liquid metasilicate (C2) required to restructure a source liquid (C2) is determined using a formula described herein-below, which varies based on the composition of the source liquid and its desired use.

If the liquid to be treated goes through atmospheric pressure (open tank, channel or open pipe) or under normal temperature or pressure conditions, then following steps apply for mixing Cl and C2: (i) Cl is mixed with source liquid via under turbulent conditions or via cavitation induced by using flotation modes, recirculating pumps creating vacuum and/or a Venturi apparatus; (ii) C2 is mixed with the source liquid via existing conventional dosing pumps, gravitation dosifiers, or analogous methods apparent to a person with ordinary skill in the art. The FLPH of Cl is in then measured in liters per hour using a formula specific that varies based on the composition of the source liquid and process conditions, described further herein-below which varies based on the composition of the source liquid, process conditions, and the desired use for the source liquid. The volume (milliliters) of liquid metasilicate required to restructure water (C2) is determined using a formula described herein-below, which also varies based on the composition of the source liquid, process conditions, and the desired use for the source liquid. The minimum contact of C2 in the source liquid reservoir or container is typically between 15-30 minutes to achieve a negative ORP. If the residual negative ORP value (my) is less than −200 mV, then contact time is extended until the ORP is more negative than −200 mV.

The stability of the liquid water is increased because the reducing water is substantially free of oxidants because they are effectively neutralized via the reduction process, particularly oxidants such as of calcium hypochlorite, sodium hypochlorite, gaseous chlorine, bromine, iodine, ozone, and/or ultraviolet light. The thus restructured water may then be used to prepare a cell culture medium of the present invention.

In some embodiments, the reducing liquid is restructured water or a restructured aqueous solution.

In some embodiments, the reducing liquid obtained has a pH of about 7, or 7-14, or 7-13, or 7-12, or 7-11, or 7-10, or 7-9, or 7-8, or 8-14, or 8-13, or 8-12, or 8-11, or 8-10, or 8-9, or 9-14, or 9-13, or 9-12, or 9-11, or 9-10, or 10-14, or 10-13, or 10-12, or 10-11, or 11-14, or 11-13, or 11-12, or 12-14, or 12-13, or 13-14.

In other embodiments, the obtained reducing liquid has a pH of at least about 7.0. In certain other embodiments, the obtained reducing liquid has a pH of at least about 9.5. In certain embodiments, the obtained reducing liquid has a pH of at least about 13.0.

Further, after undergoing the restructuring process, despite an alkaline pH of over 9.5 measured as equivalent oxidation reduction potential (ORP) greater than (−300 mv), the resulting solution is nonetheless non-caustic, and non-toxic to mammals (e.g., humans and animals such as pets) upon contact or ingestion, including an even highly alkaline pH of over 13.0 with ORP value greater than (−550 mv).

The addition/infusion of the liquid metasilicate is not chemically induced, nor produced by alkaline chemicals (such as sodium hydroxide, sodium bicarbonate, etc.).

In an aspect, the restructuring described herein lowers the ORP value of a liquid.

In some embodiments, the restructuring converts the ORP from a positive to a negative value. Decreasing the ORP charge to a negative value is desirable because it alleviates the oxidative stress of a system, which is known in the art to be harmful to a particular system.

In other embodiments, a composition (e.g., a reducing gas or reducing liquid) used in the method of the present invention has an ORP value of −50 mV or more negative, or −100 mV or more negative, or −200 mV or more negative, or −300 mV or more negative, or −400 mV or more negative, or about −50 mV to about −800 mV, or about −400 mV to about −600 mV, preferably about −300 mV to about −500 mV, more preferably about −200 mV to about −400 mV. In some embodiments, the composition has an ORP value of −800 mV or even more negative.

Further, compared to the non-restructured form of the same liquid, the restructured form of the liquid will exhibit additional properties, for example, a pH greater than 7, decreased surface tension, improved hydration, improved bio-assimilation, improved solubility of organic or inorganic compounds with the liquid, and antimicrobial properties.

The present inventors have found that the electrolytic process described herein releases free electrical charge via the water-based reducing gas and, optionally, the liquid metasilicate and its reducing, high alkaline, non-caustic, and nontoxic properties.

### OTHER EMBODIMENTS

A method for decomposing particulate pollutants in an exhaust source, the method comprising: (i) injecting, via a first series of nozzles, a reducing gas into the exhaust source containing the particulate pollutants in an exhaust; (ii) injecting, via the first series of nozzles or a second series of nozzles, a combustible gas into the exhaust source; and (iii) igniting the combustible gas in the presence of the reducing gas, thereby decomposing the particulate pollutants.

The method of paragraph 125, wherein the exhaust source is an exhaust stack.

The method of paragraph 126, wherein the exhaust stack is in communication with a manufacturing plant.

The method of paragraph 126, wherein the exhaust stack is in communication with a vehicle.

The method of any one of paragraphs 125-128, wherein the combustible gas is hydrogen, oxygen, or an alkane.

The method of any one of paragraphs 125-129, wherein the combustible gas is ignited by introducing an ignition source into the exhaust source.

The method of any one of paragraphs 126-129, wherein the combustible gas is ignited by heating the exhaust stack to a temperature of at least 454 degrees Fahrenheit.

The method of any one of paragraphs 126-131, wherein, following step (iii), exhaust exiting the exhaust stack contains about 50% or less of the particulate pollutants as compared to the exhaust exiting the exhaust stack prior to ignition.

The method of any one of paragraphs 126-131, wherein, following step (iii), exhaust exiting the exhaust stack contains about 70% or less of the particulate pollutants as compared to exhaust exiting the exhaust stack prior to ignition.

The method of any one of paragraphs 125-133, wherein the particulate pollutants have an average diameter of about 100 nm or more.

The method of any one of paragraphs 125-133, wherein the particulate pollutants have an average diameter of about 500 nm or more.

The method of any one of paragraphs 126-135, wherein the first series of nozzles and, optionally, the second series of nozzles, is disposed in the exhaust stack in a circular, spiral or helical arrangement.

A method for decomposing particulate pollutants in an exhaust source, the method comprising: (i) infusing a liquid with a reducing gas and a metasilicate, wherein the infusing involves mixing under turbulent conditions, wherein the reducing gas and/or the metasilicate reacts with the aqueous solution to produce a reducing liquid having the oxidation reduction potential (ORP) value of about −100 mV or more negative; (ii) injecting or spraying, via a first series of nozzles, the reducing liquid into the exhaust source comprising the particulate pollutants; (iii) injecting, via the first series of nozzles or a second series of nozzles, a combustible gas into the exhaust source; and (iv) igniting the combustible gas in the presence of the reducing liquid, thereby decomposing the particulate pollutants.

The method of paragraph 137, wherein an exhaust source is an exhaust stack.

The method of paragraph 138, wherein the exhaust stack is in communication with a manufacturing plant.

The method of paragraph 138, wherein the exhaust stack is in communication with a vehicle.

The method of any one of paragraphs 137-140, wherein the combustible gas is hydrogen, oxygen, or an alkane.

The method of any one of paragraphs 137-141, wherein the combustible gas is ignited by actuating or introducing an ignition source into the exhaust source.

The method of any one of paragraphs 137-141, wherein the combustible gas is ignited by heating the exhaust source to a temperature of at least 454 degrees Fahrenheit.

The method of any one of paragraphs 138-143, wherein, following step (iii), exhaust exiting the exhaust stack contains about 50% or less of the particulate pollutants as compared to the exhaust exiting the exhaust stack prior to ignition.

The method of any one of paragraphs 138-143, wherein, following step (iii), exhaust exiting the exhaust stack contains about 70% or less of the particulate pollutants as compared to exhaust exiting the exhaust stack prior to ignition.

The method of any one of paragraphs 137-145, wherein the particulate pollutants have an average diameter of about 100 nm or more.

The method of any one of paragraphs 137-145, wherein the particulate pollutants have an average diameter of about 500 nm or more.

The method of any one of paragraphs 138-147, wherein the first series of nozzles and, optionally, the second series of nozzles, is/are disposed in the exhaust stack in a circular, spiral or helical arrangement.

A system for decomposing particulate pollutants, the system comprising: (a) an exhaust stack receiving particulate pollutants from an exhaust source; (b) a heating source or ignition source; and (c) a plurality of nozzles, each nozzle injecting into the exhaust stack either: (i) reducing fluid from a reducing fluid exit line and combustible gas from a combustible gas exit line, wherein the reducing fluid exit line receives reducing fluid from a reducing fluid injection line and the combustible gas exit line receives combustible gas from a combustion gas injection line, or (ii) a mixture of reducing fluid and combustible gas from a single fluid exit line, wherein the reducing fluid flows into the single fluid exit line via a reducing fluid injection line and the combustible gas flows into the single fluid exit line via a combustible gas injection line, or (iii) a combination of (i) and (ii), wherein the nozzles and fluid injection lines are configured so that both the reducing fluid and the combustible gas are injected or sprayed into the exhaust stack, and wherein the heating source or ignition source ignites the combustible gas injected or sprayed into the exhaust stack in the presence of the reducing fluid, thereby resulting in decomposition of the particulate pollutants in the exhaust stack and reduction in particulate pollutants exiting the exhaust stack.

The system of paragraph 149, wherein each nozzle injects into the exhaust stack: (i) reducing fluid from a reducing fluid exit line and combustible gas from a combustible gas exit line, wherein the reducing fluid exit line receives reducing fluid from a reducing fluid injection line and the combustible gas exit line receives combustible gas from a combustion gas injection line.

The system of paragraph 149, wherein each nozzle injects into the exhaust stack: (ii) a mixture of reducing fluid and combustible gas from a single fluid exit line, wherein the reducing fluid flows into the single fluid exit line via a reducing fluid injection line and the combustible gas flows into the single fluid exit line via a combustible gas injection line.

The system of any one of paragraphs 149-151, wherein a fluid exit line laterally encircles the exhaust stack in a ring arrangement, and wherein the fluid exit line is connectively linked to the plurality of nozzles, optionally wherein the fluid exit line is supported by a support member connectively linked to the wall of the exhaust stack.

The system of any one of paragraphs 149-151, wherein a fluid exit line is spirally or helically wound around the exhaust stack in a vertical direction, and wherein the fluid exit line is connectively linked to the plurality of nozzles, optionally wherein the fluid exit line is supported by a support member connectively linked to the wall of the exhaust stack.

The system of any one of paragraphs 149-153, wherein the exhaust stack is in communication with a manufacturing plant.

The system of any one of paragraphs 149-153, wherein the exhaust stack is in communication with a vehicle.

The system of any one of paragraphs 149-153, wherein the reducing fluid is a reducing gas.

The system of paragraph 156, wherein the reducing gas is Hydrogas, oxyhydrogen (Knell gas), Brown's Gas, Tylar Gas, or HHO Gas (Klein Gas).

The system of any one of paragraphs 149-153, wherein the reducing fluid is a reducing liquid.

The system of paragraph 158, wherein the reducing liquid is produced by infusing an aqueous solution with a reducing gas and a metasilicate, wherein the infusing involves mixing under turbulent conditions, wherein the reducing gas and/or the metasilicate reacts with the aqueous solution.

The system of paragraph 158, wherein the reducing liquid comprises a combination of reducing, negatively charged gas, and a reducing, alkaline liquid, optionally wherein the negatively charged gas is Hydrogas and the reducing, high alkaline liquid comprises an ORP liquid or HRNORP liquid, optionally in combination with a reformed sodium metasilicate (RLS).

The system of paragraph 158-160, wherein the reducing liquid has an oxidation potential (ORP) value of about −100 mV or more negative.

The system of any one of paragraphs 149-161, wherein the combustible gas is hydrogen, oxygen, or an alkane.

A method for decomposing particulate pollutants from the system of paragraph 162, the method comprising: (i) injecting, via the plurality of nozzles, the reducing fluid and the combustible gas into the exhaust stack; and (ii) igniting the combustible gas in the presence of the reducing fluid, wherein the particulate pollutants are decomposed and the amount of particulate pollutants exiting the exhaust stack is reduced.

The method of paragraph 163, wherein the reducing fluid is a reducing gas.

The method of paragraph 164, wherein the reducing gas is wherein the reducing gas is Hydrogas, oxyhydrogen (Knell gas), Brown's Gas, Tylar Gas, or HHO Gas (Klein Gas).

The method of any one of paragraphs 163, wherein the reducing fluid is a reducing liquid.

The method of paragraph 166, wherein the reducing liquid is produced by infusing an aqueous solution with a reducing gas and a metasilicate, wherein the infusing involves mixing under turbulent conditions, wherein the reducing gas and/or the metasilicate reacts with the aqueous solution.

The method of paragraph 166, wherein the reducing liquid comprises a combination of reducing, negatively charged gas, and a reducing, alkaline liquid, optionally wherein the negatively charged gas is Hydrogas and the reducing, high alkaline liquid comprises an ORP liquid or HRNORP liquid, optionally in combination with a reformed sodium metasilicate (RLS).

The method of any one of paragraphs 166-168, wherein the reducing liquid has an oxidation potential (ORP) value of about −100 mV or more negative.

The method of any one of paragraphs 163-169, wherein the combustible gas is hydrogen, oxygen, or an alkane.

The method of any one of paragraph 163-170, wherein the combustible gas is ignited by actuating the ignition source.

The method of any one of paragraphs 163-170, wherein the combustible gas is ignited by heating the exhaust stack to a temperature of at least 454 degrees Fahrenheit.

The method of any one of paragraphs 163-172, wherein, following step (iii), exhaust exiting the exhaust stack contains about 50% or less of the particulate pollutants as compared to exhaust exiting the exhaust stack prior to ignition.

The method of any one of paragraphs 163-172, wherein, following step (iii), exhaust exiting the exhaust stack contains about 70% or less of the particulate pollutants as compared to exhaust exiting the exhaust stack prior to ignition.

The method of any one of paragraphs 163-174, wherein the particulate pollutants have an average diameter of about 100 nm or more.

The method of any one of paragraphs 163-174, wherein the particulate pollutants have an average diameter of about 500 nm or more.

The method of any one of paragraphs 163-176, wherein the plurality of nozzles is provided in a circular ring arrangement.

The method of any one of paragraphs 163-176, wherein the plurality of nozzles is provided in a spiral or helical arrangement.

The method of any one of paragraphs 163-169, wherein the exhaust stack is in communication with a manufacturing plant.

The method of any one of paragraphs 163-178, wherein the exhaust stack is in communication with a vehicle.

### Further Considerations

While the disclosure has been described in connection with specific embodiments thereof, it will be understood that it is capable of further modifications and this application is intended to cover any variations, uses, or adaptations of the disclosure following, in general, the principles of the disclosure and including such departures from the disclosure that come within known or customary practice within the art to which the disclosure pertains and may be applied to the essential features hereinbefore set forth, and follows in the scope of the claims. Other embodiments are within the claims.

The foregoing description is provided to enable a person skilled in the art to practice the various configurations described herein. While the subject technology has been particularly described with reference to the various figures and configurations, it should be understood that the figures and configurations are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

Furthermore, to the extent that the term “include,” “have,” or the like is used in the description or the claims, such term is intended to be inclusive in a manner similar to the term “comprise”, as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

1. A method for decomposing particulate pollutants in an exhaust source, the method comprising:
(i) injecting or spraying, via a first series of nozzles, a reducing fluid into the exhaust source containing the particulate pollutants;
(ii) injecting, via the first series of nozzles or a second series of nozzles, a combustible gas into the exhaust source; and
(iii) igniting the combustible gas in the presence of the reducing fluid,
thereby decomposing the particulate pollutants.

2. The method of claim 1, comprising injecting or spraying, via the first series of nozzles, a reducing gas.

3. (canceled)

4. The method of claim 1, wherein the reducing liquid is made by infusing a liquid with a reducing gas and a metasilicate, wherein the infusing involves mixing under turbulent conditions, wherein the reducing gas and/or the metasilicate reacts with the aqueous solution to produce a reducing liquid having the oxidation reduction potential (ORP) value of about −100 mV or more negative.

5. The method of claim 1, wherein the exhaust source is an exhaust stack.

6. The method of claim 5, wherein the exhaust stack is in communication with a manufacturing plant or a vehicle.

7. (canceled)

8. The method of claim 1, wherein the combustible gas is hydrogen, oxygen, or an alkane.

9. The method of claim 1, wherein the combustible gas is ignited by introducing an ignition source into the exhaust source or heating the exhaust source to a temperature of at least 454 degrees Fahrenheit.

10-15. (canceled)

16. A system for decomposing particulate pollutants, the system comprising:
(a) an exhaust stack receiving particulate pollutants;
(b) a heating source or ignition source; and
(c) a plurality of nozzles, each nozzle injecting or spraying into the exhaust stack either:
(i) reducing fluid from a reducing fluid exit line and combustible gas from a combustible gas exit line, wherein the reducing fluid exit line receives reducing fluid from a reducing fluid injection line and the combustible gas exit line receives combustible gas from a combustion gas injection line, or
(ii) a mixture of reducing fluid and combustible gas from a single fluid exit line, wherein the reducing fluid flows into the single fluid exit line via a reducing fluid injection line and the combustible gas flows into the single fluid exit line via a combustible gas injection line, or
(iii) a combination of (i) and (ii),
wherein the nozzles and fluid injection lines are configured so that both the reducing fluid and the combustible gas are injected or sprayed into the exhaust stack, and
wherein the heating source or ignition source ignites the combustible gas injected into the exhaust stack in the presence of the reducing fluid, thereby resulting in decomposition of the particulate pollutants in the exhaust stack and reduction in particulate pollutants exiting the exhaust stack.

17. The system of claim 16, wherein each nozzle injects into the exhaust stack: (i) reducing fluid from a reducing fluid exit line and combustible gas from a combustible gas exit line, wherein the reducing fluid exit line receives reducing fluid from a reducing fluid injection line and the combustible gas exit line receives combustible gas from a combustion gas injection line.

18. The system of claim 16, wherein each nozzle injects into the exhaust stack: (ii) a mixture of reducing fluid and combustible gas from a single fluid exit line, wherein the reducing fluid flows into the single fluid exit line via a reducing fluid injection line and the combustible gas flows into the single fluid exit line via a combustible gas injection line.

19. The system of claim 16, wherein a fluid exit line laterally encircles the exhaust stack in a ring arrangement, and wherein the fluid exit line is connectively linked to the plurality of nozzles, optionally wherein the fluid exit line is supported by a support member connectively linked to the wall of the exhaust stack.

20. The system of claim 16, wherein a fluid exit line is spirally or helically wound around the exhaust stack in a vertical direction, and wherein the fluid exit line is connectively linked to the plurality of nozzles, optionally wherein the fluid exit line is supported by a support member connectively linked to the wall of the exhaust stack.

21. The system of claim 16, wherein the exhaust stack is in communication with a manufacturing plant or a vehicle.

22-29. (canceled)

30. A method for decomposing particulate pollutants from the system of claim 16, the method comprising:
(i) injecting or spraying, via the plurality of nozzles, the reducing fluid and the combustible gas into the exhaust stack; and
(ii) igniting the combustible gas in the presence of the reducing fluid,
wherein the particulate pollutants are decomposed and the amount of particulate pollutants exiting the exhaust stack is reduced.

31. The method of claim 30, wherein the reducing fluid is a reducing gas, optionally wherein the reducing gas is Hydrogas, oxyhydrogen (Knell gas), Brown's Gas, Tylar Gas, or HHO Gas (Klein Gas).

32. (canceled)

33. The method of claim 31, wherein the combustible gas is hydrogen, oxygen, or an alkane.

34. The method of claim 30, wherein the combustible gas is ignited by actuating the ignition source or by heating the exhaust stack to a temperature of at least 454 degrees Fahrenheit.

35. (canceled)

36. The method of claim 30, wherein, following step (iii), exhaust exiting from the exhaust stack contains about 50% or less of the particulate pollutants as compared to exhaust exiting the exhaust stack in the absence of the method.

37. The method of claim 30, wherein following step (iii), the particulate pollutants have decomposed by at least 50% compared to the particulate pollutants in the absence of the method.

38. The method of claim 30, wherein the exhaust emitted from the exhaust stack is substantially or essentially free of particulate pollutants having an average diameter of about 500 nm or more.

39-42. (canceled)
